(19) United States
(12) Patent Application Publication
(10) Pub. No.: US 2012/0256758 A1
(43) Pub. Date: Oct. 11, 2012

(54) Dishwasher (Water, Electricity, Detergent) Conservation System

(76) Inventor: Steven Patrick Pascale, San Clemente, CA (US)

(21) Appl. No.: 13/367,107

(22) Filed: Feb. 6, 2012

Related U.S. Application Data
(60) Provisional application No. 61/516,835, filed on Apr. 9, 2011.

(51) Int. Cl. G08B 5/00

(52) U.S. Cl. 340/815.65

(57) ABSTRACT

Invention was created for the conservation of water. An ecofriendly apparatus is specifically designed for Kitchen Dishwasher use. According to R. Waskom, Colorado State University & Director, Colorado Water Institute, June 2010 states: “Changing water use habits is easy, saves money, and offers a way for a family to work together on conservation. Furthermore, running the dishwasher only when it's full can save 1,000 gallons of water per month.” Hence, to ensure communication among family members or roommates, a dishwasher conservation system could be used for facilitating communication/coordination of dishwashing task: “Clean/Unload”, “Dirty”, or “Load/Start” in order to save thousands of gallons of water per year per household. In addition, energy and money can be saved at the same time.

### REFERENCE TO RELATED APPLICATIONS

This patent application claims the benefit of U.S. Provisional Application No. 61/516,835 filed on Apr. 9, 2011, the disclosure of which is incorporated herein by reference in its entirety.

### BACKGROUND OF THE INVENTION

1. Field of the Invention

The present invention relates to a method and system for facilitating the coordination of dishwashing tasks, and more particularly to a method and system which could be used for facilitating communication/coordination of dishwashing task in order to conserve water, detergent and energy.

2. Description of Related Art

Household members may forget to put cleaned dishes back to kitchen cabinet and leave the cleaned dishes inside the dishwasher without notifying other family members. When other family members notice that the dishwasher is full of dishes they may turn on the dishwasher and wash the cleaned dishes again. This type of mis-communication wastes water, soap, energy and money. Even if a household member wants to leave other family members a message that the dishes in the dishwasher is clean, he/she may not have a pen or paper on hand or has no place to put such note to remind other family members. Therefore, there exists a need for an efficient management apparatus that enables efficient communication between family members to let other family members know whether the dishes are clean or dirty and whether the dishes are loaded enough and ready for wash in order to conserve water, soap, energy as well as save money. Simply, this need also exists among adults sharing an apartment or house. An example may be roommates in college. So far, there is no prior art addresses to the aforementioned need.

### SUMMARY OF THE INVENTION

The present Invention was created for the conservation of water, soap, and energy. An ecofriendly apparatus that helps people conserve the earth's vital resources is specifically designed for Kitchen Dishwasher use.

According to R. Waskom, Colorado State University & Director, Colorado Water Institute, June 2010 states: “Changing water use habits is easy, saves money, and offers a way for a family to work together on conservation. Running the dishwasher only when it's full can save 1,000 gallons of water per month. Hence, to ensure communication among family members or roommates, a dishwasher conservation management apparatus could be used for facilitate coordination of: “Clean/Unload”, “Dirty”, or “Load/Start” in order to save thousands of gallons of water per year per household. In addition to saving water, the electricity used for dishwashing can be saved.

One embodiment of the dishwasher conservation system according to the present invention is designed to sit stationary on the magnetic surface of dishwasher. The apparatus comprises a magnetic plate which has a plurality of die-cut peg holes indicating desired tasks to be communicated to others and a plurality of male magnetic pegs. When a household member for a particular dishwasher task wants to communicate a message related to the conservation operation desired, she/he transfers the magnetic pegs to the desired communication hole.

The magnetic plate, comprising a first magnetic layer, a second layer comprised of a card stock, plastic or vinyl material, and a third outer surface made of a polypropylene thermoplastic polymer laminate. An adhesive is used between the first and second layers, whereas the second and third layers are paired using thermal heat which activates the adhesive contained on the back surface of the polymer. An alternative to this combination would be to utilize use of ultra-violet cured coating that can be applied over the printed card stock in very thin films which is less expensive than polypropylene. Yet, another alternative is to print-silk screen directly on magnetic material or decal paper where both UV coating and polypropylene could be alleviated.

The method of media printing on magnetic material can be accomplished using screen printing or lithography on a card stock followed by providing a polymer surface layer. In doing so, the apparatus is wet erasable. Utilizing a vinyl can make a surface susceptible to smearing.

The magnetic plate is ergonomically designed but can be made from a variety of shapes and sizes. One embodiment includes 4 lobes at each corner with concaved sides. The magnetic pegs can have a variety of shapes and sizes to match with the die-cut peg holes on the magnetic plate for use.

Magnetic material can be made from a lead-free & barium-free non toxic substrate with a thickness of 0.012″ (30 lbs. Pull per Ft. Squared), 0.015 (40 lbs. Pull per Ft. Squared), 0.020″ (60 lbs. Pull per Ft. Squared), 0.030 (85 lbs. Pull per Ft. Squared), 0.045 (115 lbs. Pull per Ft. Squared), and 0.060 (145 lbs. Pull per Ft. Squared). In doing so, the apparatus is adapted for magnetically attaching on a metal surface having a magnetic attraction.

In another embodiment, the dishwasher conservation system further comprises a magnetic receiver unit which has an adhesive backing that can be applied to a non-magnetic surface of the dishwasher such that the dishwasher apparatus can be attached via a polar attraction. Said receiver plate has a re-adherable backing (without leaving a residue). This magnetic receiver unit further prevents the magnetic neodymium peg from scratching the surface of the dishwasher when being used.

The present invention can also contain an advertisement. The apparatus is about 2.5″ wide and about 3.2″ long. The grain of the paper and Magnet are either long or cross-grains on the apparatus to provide maximum strength from bending top to bottom.

Another embodiment of the dishwasher conservation system according to the present invention comprises an electronic display system that is built in the dishwasher. The electronic display system is located on the dishwasher panel, having a plurality of indicia light emitted diode (LED) lights to illuminate the desired function (Dirty, Final Load & Start, Clean & Unload) to other family members. Each has a different color indicating a different dishwashing task, for example, Green stands for Clean & Unload, Red stands for Dirty, and Yellow stands for Final Load & Start. The LED has various colors including but not limited to red, yellow and green colors.

In one embodiment of the electronic display, the LED lights is an electrical wheel device that manually switches and signals the desired functionality based on color code designation in user manual.

This electronic dishwasher conservation system may further comprise electronic sensors built in the dishwasher to control the electronic display system. The electronic sensors may include a flow sensor capable of detecting that the dishwasher has been turned on, water is flowing, and the desired cycle has been completed, thus; switching the indicia LED representing desired function from “Final Load & Start” to “Clean & Unload” by way of an electrical circuit. A heat sensor capable of detecting heat at the end of the dish wash cycle may also be utilized to control the electronic display system. The heat sensor once no longer detects heat will switch the indicia LED from the light illuminating desired function “Final Load & Start” to “Clean & Unload” by way of an electrical circuit. Alternatively, the electronic circuitry can be set up such that when the dishwasher finishes the last cycle of the dish washing process, the electronic circuitry will switch the light from desired function “Final Load & Start” to “Clean & Unload”.

The electronic sensors may also include a upper-lower tray weight sensor capable of detecting weight of dishes and silverware on the trays, thus; switching the indicia LED (Light Emitting Diode) representing desired function from “Clean & Unload” to “Final Load & Start” to indicate that the clean dishes and silverware have been removed and that subsequent activity is the placing of dirty dishes in the dishwasher compartment awaiting a full load prior to the trigger of “Final Load-Start”.

The electronic dishwasher conservation system may simply comprise push buttons built in the dishwasher for users to manually control the electronic display system by pressing the push buttons. The electrical push button technology adheres to CE, ISO, FDA certification with enclosures fabricated with gauged material and locking hinge cover for electrical wire light switch interlock.

The method of or arrangement of wiring or connecting the electronic components (for example, electronic sensors, LED lights, and push buttons) as well as mounting them will be known to those with ordinary skill in the electronic and mechanical arts.

In the case that either an electrical switch or a magnetic-neodymium peg is not used, a mat thermoplastic polymer surface coupled with a dry or wet erase pen can be appropriately used to denote instructions of operations (Green=Clean & Unload, Red=Dirty, and Yellow=Final Load & Start).

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates a front view of the dishwasher conservation system according to a first embodiment of the present invention where the apparatus with 3 separate “female” die-cut peg holes that are designed to house “male” pegs and clip for special instructions or soap coupons are demonstrated.

FIG. 2 demonstrates a front view and a side view of a circular shaped “male” peg, a square shaped “male” peg and a triangular shaped “male” peg that can be placed into the “female” die-cut holes in the first embodiment.

FIG. 3 illustrates a front view of the dishwasher conservation system according to a second embodiment of the present invention where the apparatus with “female” category wheel die cut that is designed to house a category wheel “male” peg.

FIG. 4 illustrates a front view of the dishwasher conservation system according to a third embodiment of the present invention where the apparatus having Velcro or elastic band with metal ball for honing on dishwasher knob to be used for dishwashers without magnetic capability.

FIG. 5 illustrates a front view of the dishwasher conservation system with magnetic receiving unit on a dishwasher panel.

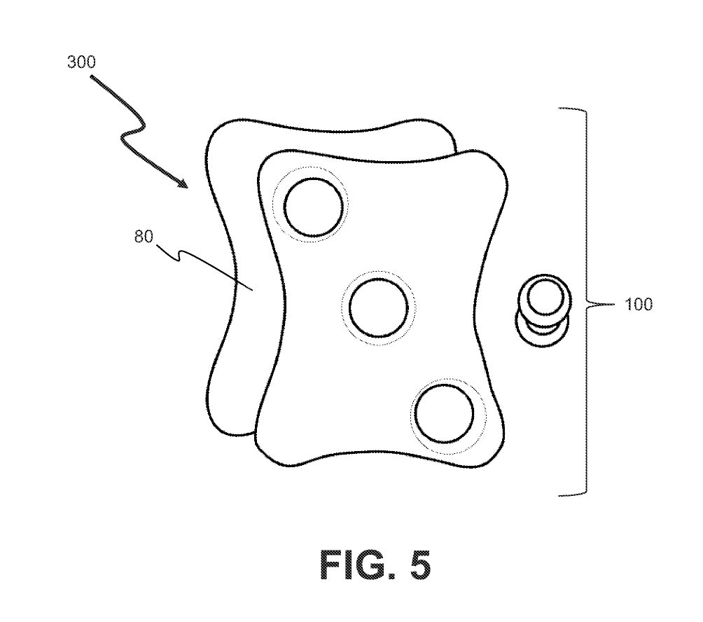

FIG. 6 illustrates a front view of the dishwasher conservation system which has an electronic display directly built into the dishwasher panel utilizing current technology for electronic display like LED and push button activation of said user command indicia color.

### DESCRIPTION OF THE PREFERRED EMBODIMENT

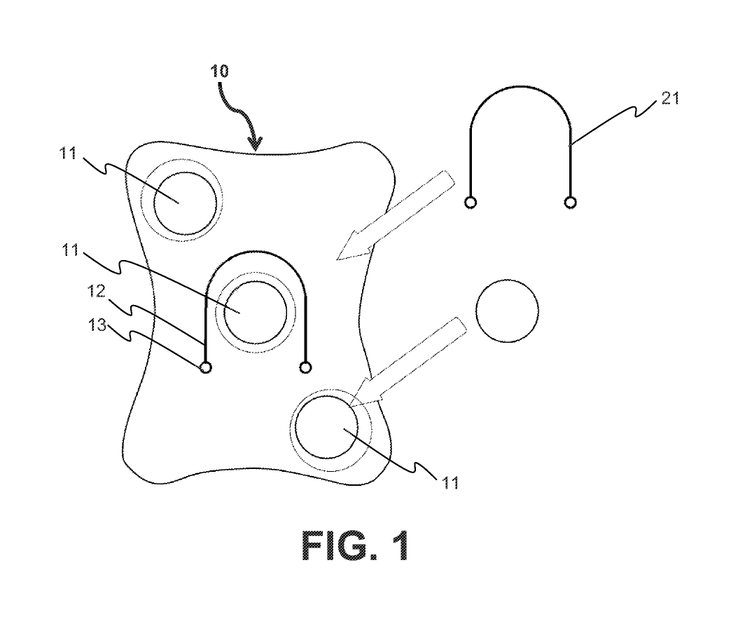

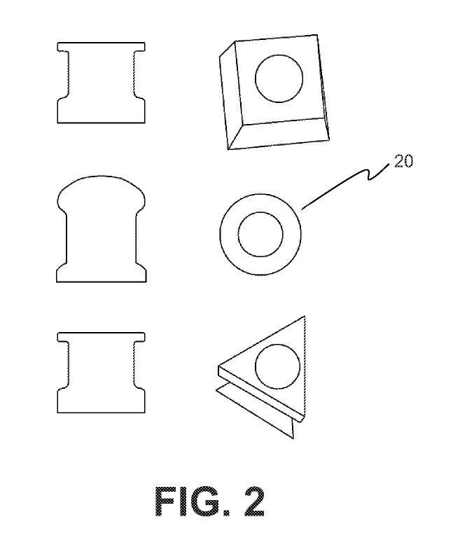

Referring to FIG. 1, there is disclosed a front view of a dishwasher conservation system 1 according to a first embodiment 100 of the present invention where the apparatus comprises a magnetic plate 10 with three separate “female” die-cut peg holes 11 that are designed to house magnetic “male” pegs 20 and at least one “male” peg 20. The design ensures maximum structural strength by placing the peg die-cuts 11 in a diagonal fashion starting from either upper left or right to center then to lower right or left. The hole 11 shown on the drawing is about 0.594″ or 19/32″ (in diameter) but can be larger or smaller. The hole 11 designs can range in shapes and sizes with a multitude of sides such as circle, rectangle-square, triangle etc. To that extent, utilizing a die cut 11 in this fashion allows the about 0.562″ (in diameter) magnetic peg 20 to be placed through the designated magnetic plate die-cut hole 11 directly on to the dishwasher metal surface. FIG. 2 showed the front view and side view of square, circular, and triangular shaped “male” peg 20 that can be used in the magnetic plate 10 having compatible shaped die-cut holes 11.

The apparatus 100 utilizes multiple colors coded designation that allows instructions to be given at a glance much like a traffic light. The upper green color stands for “clean/unload” giving an instruction that the dishes are clean and should be unloaded from the dishwasher. The middle red color stands for “dirty” giving an instruction that the dishes are dirty but the dirty dishes are not yet a full load. The lower yellow color stands for “load/start” giving an instruction that the dishes are already a full load and the dishwasher should be started. Visual cues used in this fashion can be universally applied across all countries.

Additionally, the mid-section of the apparatus has a clip die cut 12 around the center hole. This unique design utilizes two small punch die cut holes 13 at the base of the horse shoe clip 12 allowing a dishwasher liquid soap coupon or instruction notes to be placed in it. The clip 21 is of a strength that allows it to sit through the die cut 12, 13 apparatus hole and on top of the soap coupon or instruction notes sitting in the clip section. The magnetic material on the tongue section also provides a closing capability to the dishwasher metal surface. The clip 21 is also comprised of a magnetic field like Neodymium Iron Boron 27-45 in order to hold a note or coupon.

The magnetic plate 10 is designed to sit stationary on the dishwasher. When a household member wants to communicate a message related to the conservation operation desired for a particular dishwasher task, he/she can transfer the male peg 20 to the desired communication hole 11 on the magnetic plate 10. The peg 20 can be made of a piece of metal, plastic, or wood approximately 0.562 or 9/16″ (in width) which is inserted into the apparatus die cut hole of approximately 0.594 or 19/32″ (in width) if using a round or square peg. (See FIG. 1). For example, after the dishes are cleaned the household member can transfer the male peg 20 to the upper green colored die-cut hole to notify other family members that the dishes are clean and can be unloaded.

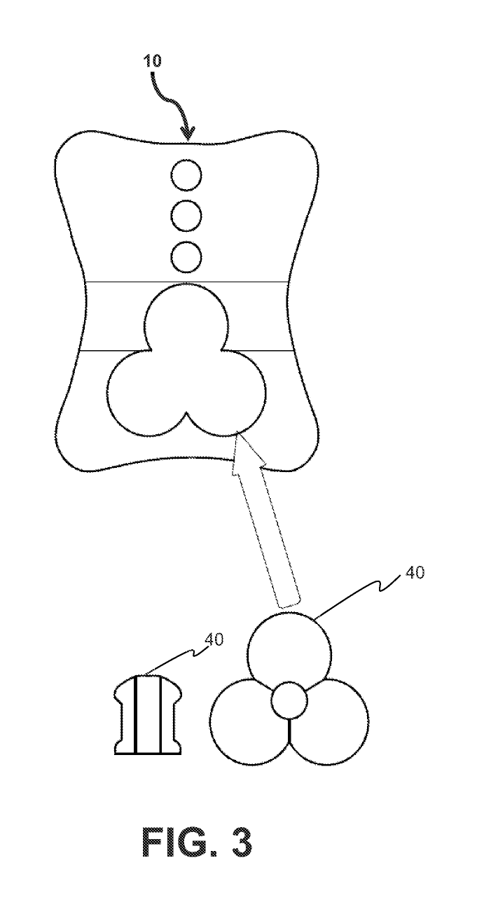

Referring to FIG. 3, there is disclosed a magnetic plate 10 and magnetic “male” peg 20 according to a second example of the present invention. Example #2 shows the mid-section is highlighted to indicate the desired operation. Noteworthy, the plate is printed and then die cut prior to being mounted to the magnet backing. In this way, the category wheel 40 is removed from the plate and permanently affixed to the peg handle where it is centered with respect to the neodymium magnet within the plastic or rubber peg handle casing.

The peg handle is used to pull and push the desired communication colored circle of the category wheel 40 into the magnetic plate 10. The indicia color is placed such that it communicates the intention of the operator relative to the desired action. For example, when a household member thinks the dishwasher already has a full load of dishes and wants other family members to start the dishwashing action, she/he may place the category wheel 40 into the magnetic plate 10 with the yellow colored circle placed into the die-cut hole at the mid-section to communicate the desired action (load/start) because the yellow color indicates “load/start” in this case.

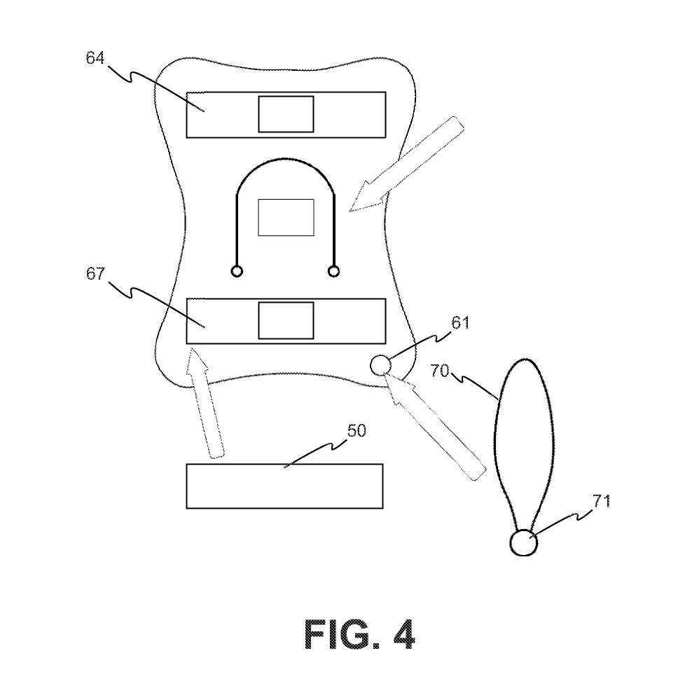

Referring to FIG. 4, there is disclosed a dishwasher conservation system designed to be used with a dishwasher without a magnetic surface. In this case, the apparatus comprises a plate 60 and Velcro strip adhesive 50. In this case, a Velcro strip adhesive 50 can be utilized on the back of the plate at the location marked 64 to attach to a dishwasher. If a Velcro strip adhesive 50 is undesirable, the plate 60 can be attached to a handle or knob on the dishwasher using an elastic band 70 with a small metal ball end 71. Located in one of the plate corners, the band 70 is fitted through a small opening 61. Ideally, this embodiment is best used with a “wet erase” surface and corresponding marker pen. The mode of operations (green-red-yellow) can be appropriately denoted and later erased for further use. Hence, the apparatus is a “Green Eco Friendly Apparatus”.

The apparatus 100 may further comprise a magnetic receiver plate 80 which has an adhesive backing that can be applied to a non-magnetic surface of the dishwasher 300 such that the dishwasher apparatus 100 can be attached to the dishwasher 300 through the polar attraction with the magnetic receiver plate 80. Said magnetic receiver plate 80 has a re-adherable backing (without leaving a residue) designed to avoid appliance scratching when utilizing the magnetic neodymium peg.

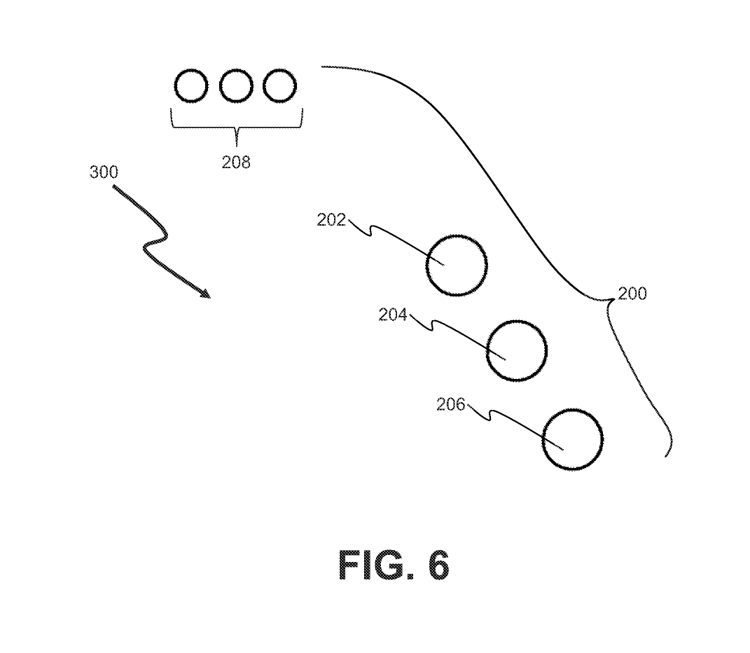

Referring to FIG. 6, there is disclosed a front view of a dishwasher conservation system 1 according to an embodiment of the present invention, which comprises an electronic display system 200. The electronic display system 200 is located on the dishwasher panel 300, having a plurality of indicia light emitted diode (LED) lights to illuminate the desired function (Dirty, Final Load & Start, Clean & Unload) to other family members. Each has a different color indicating a different dishwashing task, for example, Green 202 stands for Clean & Unload, Red 204 stands for Dirty, and Yellow 206 stands for Final Load & Start. The LED may have various colors including but is not limited to red, yellow and green colors.

This electronic dishwasher conservation system may further comprise electronic sensors (not shown) built in the dishwasher to control the electronic display system. The electronic sensors may include a flow sensor capable of detecting that the dishwasher has been turned on, water is flowing, and the desired cycle has been completed, thus; switching the indicia LED (Light Emitting Diode) representing desired function “Final Load & Start” to “Clean & Unload” by way of an electrical circuit. A heat sensor capable of detecting heat at the end of the dish wash cycle may also be utilized to control the electronic display system. The heat sensor once no longer detects heat will switch the indicia LED (Light Emitting Diode) from the light illuminating desired function “Final Load & Start” to “Clean & Unload” by way of an electrical circuit. Alternatively, the circuitry can be set up such that when the dishwasher finishes the last cycle of the dish washing process, the circuitry will switch the light from desired function “Final Load & Start” to “Clean & Unload”.

The electronic sensors may also include a upper-lower tray weight sensor capable of detecting weight of dishes silverware on the trays, thus; switching the indicia LED (Light Emitting Diode) representing desired function from “Clean & Unload” to “Final Load & Start” to indicate that the clean dishes and silverware have been removed and that subsequent predecessor activity is the placing of dirty dishes in the dishwasher compartment awaiting a full load prior to the trigger of “Final Load-Start”.

The electronic dishwasher conservation system may simply comprise push buttons 208 built in the dishwasher for users to manually control the electronic display system by pressing the push buttons.

The method of or arrangement of wiring or connecting the electronic components (for example, electronic sensors, LED lights, and push buttons) as well as mounting them will be known to those with ordinary skill in the electronic and mechanical arts.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications for consumer interested in using their resources more wisely and saving money. All such modifications and variations are within the scope of the invention as determined by the appended claims when interpreted in accordance with the breadth to which they are entitled. In all, the foregoing represents a significant breakthrough invention related to the conservation of water, electricity and detergent when utilizing a kitchen dishwasher appliance. Although a limited number of embodiments of the invention have been described in detail for purposes of illustration, once again; various modifications may be made without departing from the spirit of the invention. Accordingly, the invention is not to be limited.

What is claimed is:

1. A dishwasher conservation system to coordinate dishwashing tasks comprising:
a plate designed for magnetically attaching onto a metal surface of a dishwasher, having a plurality of die-cut holes, the plate having various shapes and sizes; and
at least one magnetic-neodymium peg that is designed to be placed into the peg holes on the magnetic plate to communicate a message related to the dishwashing operation desired, the magnetic-neodymium peg has various shapes and sizes, the magnetic-neodymium peg has various colors including but not limited to red, yellow and green colors.

2. A dishwasher conservation system to coordinate dishwashing tasks comprising:
an electronic display system that is built in the dishwasher, the electronic display system located on the dishwasher panel has a plurality of indicia LED lights to illuminate desired functions (Dirty, Final Load & Start, Clean & Unload) to other family members, each of the LED lights has a different color indicating a different desired function, the LED light has various colors including but is not limited to red, yellow and green colors.

3. The dishwasher conservation system of claim 2 further comprises at least one electronic sensor built in the dishwasher to control the electronic display system.

4. The dishwasher conservation system of claim 2 further comprises at least one push button built in the dishwasher for users to manually control the electronic display system by pressing the push button.

5. The dishwasher conservation system of claim 3 wherein the electronic sensor includes a flow sensor capable of detecting water flow at the end of a dish wash cycle and thus switching the indicia LED light representing desired function from “Final Load & Start” to “Clean & Unload” by way of an electrical circuit.

6. The dishwasher conservation system of claim 3 wherein the electronic sensor includes a heat sensor capable of detecting heat at the end of a dish wash cycle and thus switching the indicia LED light representing desired function from “Final Load & Start” to “Clean & Unload” by way of an electrical circuit.

7. The dishwasher conservation system of claim 3 wherein the electronic sensor includes an upper-lower dish tray weight sensor capable of detecting weight of dishes and silverware on the trays at the end of a dish wash cycle and thus switching the indicia LED light representing desired function from “Clean & Unload” to “Dirty” indicating that the clean dishes and silverware have been removed and that subsequent activity is the placing of dirty dishes in the dishwasher compartment awaiting a full load prior to the trigger of “Final Load & Start”, and of detecting dishwasher detergent levels in addition to the closing of the soap tray as a way the system feedback can signal a transducer of the desired LED instructions to activate the dishwasher cycle after final load has been completed.

8. The dishwasher conservation system of claim 1 wherein the magnetic plate has three die-cut holes labeled “Clean & Unload, Dirty, Final Load & Start”, respectively to indicate the desired task.

9. The dishwasher conservation system of claim 1, wherein the plate has a mid-section highlighted to indicate the desired operation, which has a die-cut hole for receiving of the category wheel in the magnetic apparatus.

10. The dishwasher conservation system of claim 1 wherein the magnetic plate further comprising multiple colors coded designation that allows instructions to be given at a glance.

11. The dishwasher conservation system of claim 1 wherein the magnetic-neodymium peg is a category wheel having two to three connected circles each has a different color indicating a different dishwashing task, the category wheel can be inserted into the die-cut hole at a mid-section of the magnetic plate to indicate the desired task.

12. The dishwasher conservation system of claim 2 wherein the LED lights is an electrical wheel device that manually switches and signals the desired functionality based on color code designation in user manual.

13. The dishwasher conservation system of claim 1 further comprises a magnetic receiver unit which has an adhesive backing that is applied to a non-magnetic surface of the dishwasher such that the dishwasher apparatus can be attached via a polar attraction, the receiver plate has a re-adherable backing designed to protect dishwasher from scratching when utilizing the magnetic neodymium peg.

14. The dishwasher conservation system of claim 1 wherein the third outer surface is made of a polypropylene thermoplastic polymer laminate.

15. A dishwasher conservation system comprises a mat thermoplastic polymer surface coupled with a dry or wet erase pen can be appropriately used to denote instructions of desired tasks including Green=Clean & Unload, Red=Dirty, and Yellow=Final Load & Start.

16. The dishwasher conservation system of claim 1 further comprising a Velcro strip adhesive on the back of the plate and a piece of Velcro strip for attaching the plate to the dishwasher.

17. The dishwasher conservation system of claim 1 further comprising a horse shoe clip for securing dishwasher detergent coupons or instructions to purchase dishwasher soap through a clip die- cut hole on the magnetic plate.

18. The dishwasher conservation system of claim 4 wherein the electrical push button technology adheres to CE, ISO, FDA certification with enclosures fabricated with gauged material and locking hinge cover for electrical wire light switch interlock.

19. The dishwasher conservation system of claim 1 wherein the magnetic plate comprising a first magnetic layer, a second layer, a third outer surface, and an adhesive is used between the first magnetic layer and the second layer.

20. The dishwasher conservation system of claim 19 wherein the second layer is made from materials selected from the group consisting of plastic, cardstock, and vinyl lamination material.

21. The dishwasher conservation system of claim 19 wherein the third outer surface is a very thin film of ultra-violet cured coating over the second layer

22. The dishwasher conservation system of claim 19 wherein the second and third layers are paired using thermal heat which activates the adhesive contained on the back surface of the polymer.

23. The dishwasher conservation system of claim 1 wherein the magnetic plate is approximately 2.5″ wide and approximately 3.2″ long.

24. The dishwasher conservation system of claim 1 wherein the die-cut hole is approximately 0.594″ wide.

25. The dishwasher conservation system of claim 1 wherein the magnetic peg is approximately 0.562″ wide.
